(19) United States
(12) Patent Application Publication
(10) Pub. No.: US 2022/0188606 A1
(43) Pub. Date: Jun. 16, 2022

(54) Memory Configuration to Support Deep Learning Accelerator in an Integrated Circuit Device

(71) Applicant: Micron Technology, Inc., Boise, ID (US)

(72) Inventor: David Andrew Roberts, Wellesley, MA (US)

(21) Appl. No.: 17/120,786

(22) Filed: Dec. 14, 2020

(51) Int. Cl. G06N 3/063; G06N 3/08; G06N 3/04

(52) U.S. Cl. CPC G06N 3/063; G06N 3/04; G06N 3/08

(57) ABSTRACT

Systems, devices, and methods related to a Deep Learning Accelerator and memory are described. For example, an integrated circuit (IC) device includes a first stack of IC dies connected to a plurality of second stacks of IC dies. The first stack has a first die of a memory controller and processing units of the Deep Learning Accelerator and at least one second die that is stacked on the first die to provide a first type of memory. Each of the second stacks has a base die and at least a third die and a fourth die having different types of memory. The base die has logic circuit configured to copy data within the same stack in response to commands from the memory controller and has a second type of memory usable as die cross buffer.

### TECHNICAL FIELD

At least some embodiments disclosed herein relate to integrated circuit devices in general and more particularly, but not limited to, integrated circuit devices having accelerators for Artificial Neural Networks (ANNs), such as ANNs configured through machine learning and/or deep learning.

### BACKGROUND

An Artificial Neural Network (ANN) uses a network of neurons to process inputs to the network and to generate outputs from the network.

Deep learning has been applied to many application fields, such as computer vision, speech/audio recognition, natural language processing, machine translation, bioinformatics, drug design, medical image processing, games, etc.

### BRIEF DESCRIPTION OF THE DRAWINGS

The embodiments are illustrated by way of example and not limitation in the figures of the accompanying drawings in which like references indicate similar elements.

FIG. 1 shows an integrated circuit device having a Deep Learning Accelerator and random access memory configured according to one embodiment.

FIG. 2 shows a processing unit configured to perform matrix-matrix operations according to one embodiment.

FIG. 3 shows a processing unit configured to perform matrix-vector operations according to one embodiment.

FIG. 4 shows a processing unit configured to perform vector-vector operations according to one embodiment.

FIG. 5 shows a Deep Learning Accelerator and random access memory configured to autonomously apply inputs to a trained Artificial Neural Network according to one embodiment.

FIG. 6 illustrates a configuration of integrated circuit dies of memory and a Deep Learning Accelerator according to one embodiment.

FIG. 7 illustrates an example of memory configuration for a Deep Learning Accelerator according to one embodiment.

FIG. 8 shows a method implemented in an integrated circuit device according to one embodiment.

### DETAILED DESCRIPTION

At least some embodiments disclosed herein provide an integrated circuit device configured to perform computations of Artificial Neural Networks (ANNs) with reduced energy consumption and computation time. The integrated circuit device includes a Deep Learning Accelerator (DLA) and random access memory. The Deep Learning Accelerator has distinct data access patterns of read-only and read-write, with multiple concurrent, large data block transfers. Thus, the integrated circuit device can use a heterogeneous memory system architecture to optimize its memory configuration in supporting the Deep Learning Accelerator for improved performance and energy usage.

The Deep Learning Accelerator (DLA) includes a set of programmable hardware computing logic that is specialized and/or optimized to perform parallel vector and/or matrix calculations, including but not limited to multiplication and accumulation of vectors and/or matrices.

Further, the Deep Learning Accelerator (DLA) can include one or more Arithmetic-Logic Units (ALUs) to perform arithmetic and bitwise operations on integer binary numbers.

The Deep Learning Accelerator (DLA) is programmable via a set of instructions to perform the computations of an Artificial Neural Network (ANN).

For example, each neuron in the ANN receives a set of inputs. Some of the inputs to a neuron can be the outputs of certain neurons in the ANN; and some of the inputs to a neuron can be the inputs provided to the ANN. The input/output relations among the neurons in the ANN represent the neuron connectivity in the ANN.

For example, each neuron can have a bias, an activation function, and a set of synaptic weights for its inputs respectively. The activation function can be in the form of a step function, a linear function, a log-sigmoid function, etc. Different neurons in the ANN can have different activation functions.

For example, each neuron can generate a weighted sum of its inputs and its bias and then produce an output that is the function of the weighted sum, computed using the activation function of the neuron.

The relations between the input(s) and the output(s) of an ANN in general are defined by an ANN model that includes the data representing the connectivity of the neurons in the ANN, as well as the bias, activation function, and synaptic weights of each neuron. Based on a given ANN model, a computing device can be configured to compute the output(s) of the ANN from a given set of inputs to the ANN.

For example, the inputs to the ANN can be generated based on camera inputs; and the outputs from the ANN can be the identification of an item, such as an event or an object.

In general, an ANN can be trained using a supervised method where the parameters in the ANN are adjusted to minimize or reduce the error between known outputs associated with or resulted from respective inputs and computed outputs generated via applying the inputs to the ANN. Examples of supervised learning/training methods include reinforcement learning and learning with error correction.

Alternatively, or in combination, an ANN can be trained using an unsupervised method where the exact outputs resulted from a given set of inputs is not known before the completion of the training. The ANN can be trained to classify an item into a plurality of categories, or data points into clusters.

Multiple training algorithms can be employed for a sophisticated machine learning/training paradigm.

Deep learning uses multiple layers of machine learning to progressively extract features from input data. For example, lower layers can be configured to identify edges in an image; and higher layers can be configured to identify, based on the edges detected using the lower layers, items captured in the image, such as faces, objects, events, etc. Deep learning can be implemented via Artificial Neural Networks (ANNs), such as deep neural networks, deep belief networks, recurrent neural networks, and/or convolutional neural networks.

The granularity of the Deep Learning Accelerator (DLA) operating on vectors and matrices corresponds to the largest unit of vectors/matrices that can be operated upon during the execution of one instruction by the Deep Learning Accelerator (DLA). During the execution of the instruction for a predefined operation on vector/matrix operands, elements of vector/matrix operands can be operated upon by the Deep Learning Accelerator (DLA) in parallel to reduce execution time and/or energy consumption associated with memory/data access. The operations on vector/matrix operands of the granularity of the Deep Learning Accelerator (DLA) can be used as building blocks to implement computations on vectors/matrices of larger sizes.

The implementation of a typical/practical Artificial Neural Network (ANN) involves vector/matrix operands having sizes that are larger than the operation granularity of the Deep Learning Accelerator (DLA). To implement such an Artificial Neural Network (ANN) using the Deep Learning Accelerator (DLA), computations involving the vector/matrix operands of large sizes can be broken down to the computations of vector/matrix operands of the granularity of the Deep Learning Accelerator (DLA). The Deep Learning Accelerator (DLA) can be programmed via instructions to carry out the computations involving large vector/matrix operands. For example, atomic computation capabilities of the Deep Learning Accelerator (DLA) in manipulating vectors and matrices of the granularity of the Deep Learning Accelerator (DLA) in response to instructions can be programmed to implement computations in an Artificial Neural Network (ANN).

In some implementations, the Deep Learning Accelerator (DLA) lacks some of the logic operation capabilities of a typical Central Processing Unit (CPU). However, the Deep Learning Accelerator (DLA) can be configured with sufficient logic units to process the input data provided to an Artificial Neural Network (ANN) and generate the output of the Artificial Neural Network (ANN) according to a set of instructions generated for the Deep Learning Accelerator (DLA). Thus, the Deep Learning Accelerator (DLA) can perform the computation of an Artificial Neural Network (ANN) with little or no help from a Central Processing Unit (CPU) or another processor. Optionally, a conventional general purpose processor can also be configured as part of the Deep Learning Accelerator (DLA) to perform operations that cannot be implemented efficiently using the vector/matrix processing units of the Deep Learning Accelerator (DLA), and/or that cannot be performed by the vector/matrix processing units of the Deep Learning Accelerator (DLA).

A typical Artificial Neural Network (ANN) can be described/specified in a standard format (e.g., Open Neural Network Exchange (ONNX)). A compiler can be used to convert the description of the Artificial Neural Network (ANN) into a set of instructions for the Deep Learning Accelerator (DLA) to perform calculations of the Artificial Neural Network (ANN). The compiler can optimize the set of instructions to improve the performance of the Deep Learning Accelerator (DLA) in implementing the Artificial Neural Network (ANN).

The Deep Learning Accelerator (DLA) can have local memory, such as registers, buffers and/or caches, configured to store vector/matrix operands and the results of vector/matrix operations. Intermediate results in the registers can be pipelined/shifted in the Deep Learning Accelerator (DLA) as operands for subsequent vector/matrix operations to reduce time and energy consumption in accessing memory/data and thus speed up typical patterns of vector/matrix operations in implementing a typical Artificial Neural Network (ANN). The capacity of registers, buffers and/or caches in the Deep Learning Accelerator (DLA) is typically insufficient to hold the entire data set for implementing the computation of a typical Artificial Neural Network (ANN). Thus, a random access memory coupled to the Deep Learning Accelerator (DLA) is configured to provide an improved data storage capability for implementing a typical Artificial Neural Network (ANN). For example, the Deep Learning Accelerator (DLA) loads data and instructions from the random access memory and stores results back into the random access memory.

The communication bandwidth between the Deep Learning Accelerator (DLA) and the random access memory is configured to optimize or maximize the utilization of the computation power of the Deep Learning Accelerator (DLA). For example, high communication bandwidth can be provided between the Deep Learning Accelerator (DLA) and the random access memory such that vector/matrix operands can be loaded from the random access memory into the Deep Learning Accelerator (DLA) and results stored back into the random access memory in a time period that is approximately equal to the time for the Deep Learning Accelerator (DLA) to perform the computations on the vector/matrix operands. The granularity of the Deep Learning Accelerator (DLA) can be configured to increase the ratio between the amount of computations performed by the Deep Learning Accelerator (DLA) and the size of the vector/matrix operands such that the data access traffic between the Deep Learning Accelerator (DLA) and the random access memory can be reduced, which can reduce the requirement on the communication bandwidth between the Deep Learning Accelerator (DLA) and the random access memory. Thus, the bottleneck in data/memory access can be reduced or eliminated.

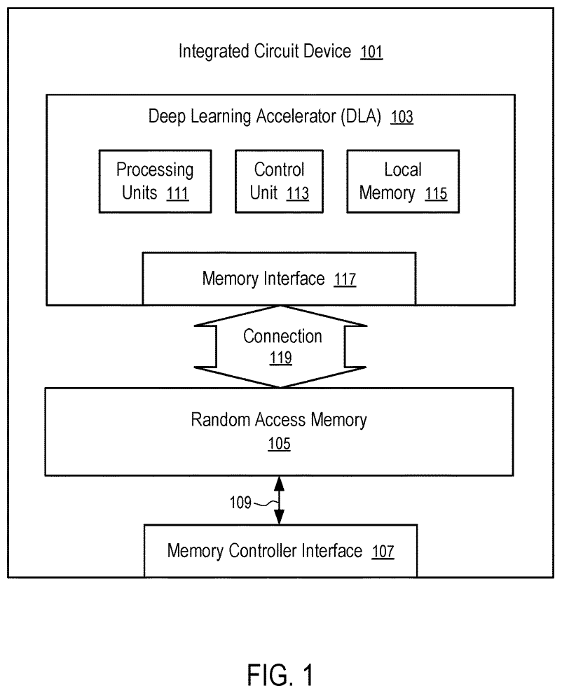

FIG. 1 shows an integrated circuit device 101 having a Deep Learning Accelerator 103 and random access memory 105 configured according to one embodiment.

The Deep Learning Accelerator 103 in FIG. 1 includes processing units 111, a control unit 113, and local memory 115. When vector and matrix operands are in the local memory 115, the control unit 113 can use the processing units 111 to perform vector and matrix operations in accordance with instructions. Further, the control unit 113 can load instructions and operands from the random access memory 105 through a memory interface 117 and a high speed/bandwidth connection 119.

The integrated circuit device 101 is configured to be enclosed within an integrated circuit package with pins or contacts for a memory controller interface 107.

The memory controller interface 107 is configured to support a standard memory access protocol such that the integrated circuit device 101 appears to a typical memory controller in a way same as a conventional random access memory device having no Deep Learning Accelerator 103. For example, a memory controller external to the integrated circuit device 101 can access, using a standard memory access protocol through the memory controller interface 107, the random access memory 105 in the integrated circuit device 101.

The integrated circuit device 101 is configured with a high bandwidth connection 119 between the random access memory 105 and the Deep Learning Accelerator 103 that are enclosed within the integrated circuit device 101. The bandwidth of the connection 119 is higher than the bandwidth of the connection 109 between the random access memory 105 and the memory controller interface 107.

In one embodiment, both the memory controller interface 107 and the memory interface 117 are configured to access the random access memory 105 via a same set of buses or wires. Thus, the bandwidth to access the random access memory 105 is shared between the memory interface 117 and the memory controller interface 107. Alternatively, the memory controller interface 107 and the memory interface 117 are configured to access the random access memory 105 via separate sets of buses or wires. Optionally, the random access memory 105 can include multiple sections that can be accessed concurrently via the connection 119. For example, when the memory interface 117 is accessing a section of the random access memory 105, the memory controller interface 107 can concurrently access another section of the random access memory 105. For example, the different sections can be configured on different integrated circuit dies and/or different planes/banks of memory cells; and the different sections can be accessed in parallel to increase throughput in accessing the random access memory 105. For example, the memory controller interface 107 is configured to access one data unit of a predetermined size at a time; and the memory interface 117 is configured to access multiple data units, each of the same predetermined size, at a time.

In one embodiment, the random access memory 105 and the integrated circuit device 101 are configured on different integrated circuit dies configured within a same integrated circuit package. Further, the random access memory 105 can be configured on one or more integrated circuit dies that allows parallel access of multiple data elements concurrently.

In some implementations, the number of data elements of a vector or matrix that can be accessed in parallel over the connection 119 corresponds to the granularity of the Deep Learning Accelerator (DLA) operating on vectors or matrices. For example, when the processing units 111 can be operated on a number of vector/matrix elements in parallel, the connection 119 is configured to load or store the same number, or multiples of the number, of elements via the connection 119 in parallel.

Optionally, the data access speed of the connection 119 can be configured based on the processing speed of the Deep Learning Accelerator 103. For example, after an amount of data and instructions have been loaded into the local memory 115, the control unit 113 can execute an instruction to operate on the data using the processing units 111 to generate output. Within the time period of processing to generate the output, the access bandwidth of the connection 119 allows the same amount of data and instructions to be loaded into the local memory 115 for the next operation and the same amount of output to be stored back to the random access memory 105. For example, while the control unit 113 is using a portion of the local memory 115 to process data and generate output, the memory interface 117 can offload the output of a prior operation into the random access memory 105 from, and load operand data and instructions into, another portion of the local memory 115. Thus, the utilization and performance of the Deep Learning Accelerator (DLA) are not restricted or reduced by the bandwidth of the connection 119.

The random access memory 105 can be used to store the model data of an Artificial Neural Network (ANN) and to buffer input data for the Artificial Neural Network (ANN). The model data does not change frequently. The model data can include the output generated by a compiler for the Deep Learning Accelerator (DLA) to implement the Artificial Neural Network (ANN). The model data typically includes matrices used in the description of the Artificial Neural Network (ANN) and instructions generated for the Deep Learning Accelerator 103 to perform vector/matrix operations of the Artificial Neural Network (ANN) based on vector/matrix operations of the granularity of the Deep Learning Accelerator 103. The instructions operate not only on the vector/matrix operations of the Artificial Neural Network (ANN), but also on the input data for the Artificial Neural Network (ANN).

In one embodiment, when the input data is loaded or updated in the random access memory 105, the control unit 113 of the Deep Learning Accelerator 103 can automatically execute the instructions for the Artificial Neural Network (ANN) to generate an output of the Artificial Neural Network (ANN). The output is stored into a predefined region in the random access memory 105. The Deep Learning Accelerator 103 can execute the instructions without help from a Central Processing Unit (CPU). Thus, communications for the coordination between the Deep Learning Accelerator 103 and a processor outside of the integrated circuit device 101 (e.g., a Central Processing Unit (CPU)) can be reduced or eliminated.

Optionally, the logic circuit of the Deep Learning Accelerator 103 can be implemented via Complementary Metal Oxide Semiconductor (CMOS). For example, the technique of CMOS Under the Array (CUA) of memory cells of the random access memory 105 can be used to implement the logic circuit of the Deep Learning Accelerator 103, including the processing units 111 and the control unit 113. Alternatively, the technique of CMOS in the Array of memory cells of the random access memory 105 can be used to implement the logic circuit of the Deep Learning Accelerator 103.

In some implementations, the Deep Learning Accelerator 103 and the random access memory 105 can be implemented on separate integrated circuit dies and connected using Through-Silicon Vias (TSV) for increased data bandwidth between the Deep Learning Accelerator 103 and the random access memory 105. For example, the Deep Learning Accelerator 103 can be formed on an integrated circuit die of a Field-Programmable Gate Array (FPGA) or Application Specific Integrated circuit (ASIC).

Alternatively, the Deep Learning Accelerator 103 and the random access memory 105 can be configured in separate integrated circuit packages and connected via multiple point-to-point connections on a printed circuit board (PCB) for parallel communications and thus increased data transfer bandwidth.

The random access memory 105 can be volatile memory or non-volatile memory, or a combination of volatile memory and non-volatile memory. Examples of non-volatile memory include flash memory, memory cells formed based on negative-and (NAND) logic gates, negative-or (NOR) logic gates, Phase-Change Memory (PCM), magnetic memory (MRAM), resistive random-access memory, cross point storage and memory devices. A cross point memory device can use transistor-less memory elements, each of which has a memory cell and a selector that are stacked together as a column. Memory element columns are connected via two lays of wires running in perpendicular directions, where wires of one lay run in one direction in the layer that is located above the memory element columns, and wires of the other lay run in another direction and are located below the memory element columns. Each memory element can be individually selected at a cross point of one wire on each of the two layers. Cross point memory devices are fast and non-volatile and can be used as a unified memory pool for processing and storage. Further examples of non-volatile memory include Read-Only Memory (ROM), Programmable Read-Only Memory (PROM), Erasable Programmable Read-Only Memory (EPROM) and Electronically Erasable Programmable Read-Only Memory (EEPROM) memory, etc. Examples of volatile memory include Dynamic Random-Access Memory (DRAM) and Static Random-Access Memory (SRAM).

For example, non-volatile memory can be configured to implement at least a portion of the random access memory 105. The non-volatile memory in the random access memory 105 can be used to store the model data of an Artificial Neural Network (ANN). Thus, after the integrated circuit device 101 is powered off and restarts, it is not necessary to reload the model data of the Artificial Neural Network (ANN) into the integrated circuit device 101. Further, the non-volatile memory can be programmable/rewritable. Thus, the model data of the Artificial Neural Network (ANN) in the integrated circuit device 101 can be updated or replaced to implement an update Artificial Neural Network (ANN), or another Artificial Neural Network (ANN).

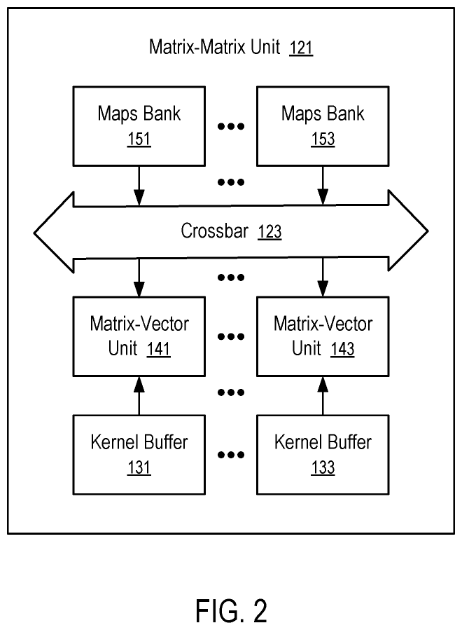

The processing units 111 of the Deep Learning Accelerator 103 can include vector-vector units, matrix-vector units, and/or matrix-matrix units. Examples of units configured to perform for vector-vector operations, matrix-vector operations, and matrix-matrix operations are discussed below in connection with FIGS. 2-4.

FIG. 2 shows a processing unit configured to perform matrix-matrix operations according to one embodiment. For example, the matrix-matrix unit 121 of FIG. 2 can be used as one of the processing units 111 of the Deep Learning Accelerator 103 of FIG. 1.

In FIG. 2, the matrix-matrix unit 121 includes multiple kernel buffers 131 to 133 and multiple the maps banks 151 to 153. Each of the maps banks 151 to 153 stores one vector of a matrix operand that has multiple vectors stored in the maps banks 151 to 153 respectively; and each of the kernel buffers 131 to 133 stores one vector of another matrix operand that has multiple vectors stored in the kernel buffers 131 to 133 respectively. The matrix-matrix unit 121 is configured to perform multiplication and accumulation operations on the elements of the two matrix operands, using multiple matrix-vector units 141 to 143 that operate in parallel.

A crossbar 123 connects the maps banks 151 to 153 to the matrix-vector units 141 to 143. The same matrix operand stored in the maps bank 151 to 153 is provided via the crossbar 123 to each of the matrix-vector units 141 to 143; and the matrix-vector units 141 to 143 receives data elements from the maps banks 151 to 153 in parallel. Each of the kernel buffers 131 to 133 is connected to a respective one in the matrix-vector units 141 to 143 and provides a vector operand to the respective matrix-vector unit. The matrix-vector units 141 to 143 operate concurrently to compute the operation of the same matrix operand, stored in the maps banks 151 to 153 multiplied by the corresponding vectors stored in the kernel buffers 131 to 133. For example, the matrix-vector unit 141 performs the multiplication operation on the matrix operand stored in the maps banks 151 to 153 and the vector operand stored in the kernel buffer 131, while the matrix-vector unit 143 is concurrently performing the multiplication operation on the matrix operand stored in the maps banks 151 to 153 and the vector operand stored in the kernel buffer 133.

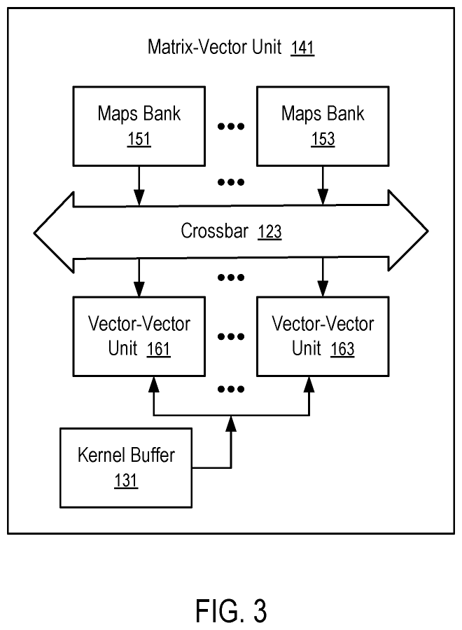

Each of the matrix-vector units 141 to 143 in FIG. 2 can be implemented in a way as illustrated in FIG. 3.

FIG. 3 shows a processing unit configured to perform matrix-vector operations according to one embodiment. For example, the matrix-vector unit 141 of FIG. 3 can be used as any of the matrix-vector units in the matrix-matrix unit 121 of FIG. 2.

In FIG. 3, each of the maps banks 151 to 153 stores one vector of a matrix operand that has multiple vectors stored in the maps banks 151 to 153 respectively, in a way similar to the maps banks 151 to 153 of FIG. 2. The crossbar 123 in FIG. 3 provides the vectors from the maps banks 151 to the vector-vector units 161 to 163 respectively. A same vector stored in the kernel buffer 131 is provided to the vector-vector units 161 to 163.

The vector-vector units 161 to 163 operate concurrently to compute the operation of the corresponding vector operands, stored in the maps banks 151 to 153 respectively, multiplied by the same vector operand that is stored in the kernel buffer 131. For example, the vector-vector unit 161 performs the multiplication operation on the vector operand stored in the maps bank 151 and the vector operand stored in the kernel buffer 131, while the vector-vector unit 163 is concurrently performing the multiplication operation on the vector operand stored in the maps bank 153 and the vector operand stored in the kernel buffer 131.

When the matrix-vector unit 141 of FIG. 3 is implemented in a matrix-matrix unit 121 of FIG. 2, the matrix-vector unit 141 can use the maps banks 151 to 153, the crossbar 123 and the kernel buffer 131 of the matrix-matrix unit 121.

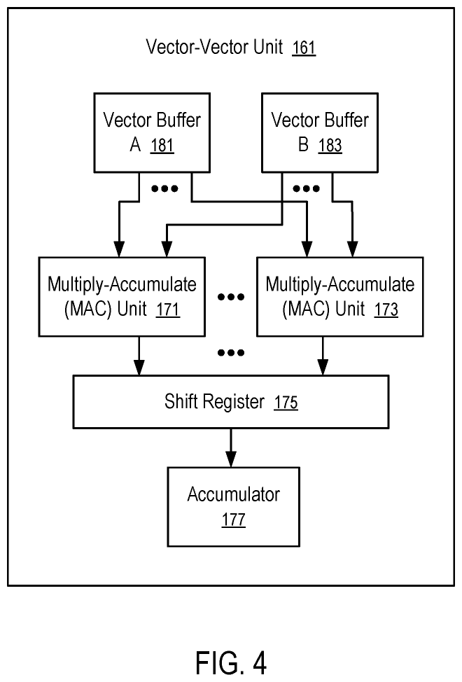

Each of the vector-vector units 161 to 163 in FIG. 3 can be implemented in a way as illustrated in FIG. 4.

FIG. 4 shows a processing unit configured to perform vector-vector operations according to one embodiment. For example, the vector-vector unit 161 of FIG. 4 can be used as any of the vector-vector units in the matrix-vector unit 141 of FIG. 3.

In FIG. 4, the vector-vector unit 161 has multiple multiply-accumulate units 171 to 173. Each of the multiply-accumulate units 171 to 173 can receive two numbers as operands, perform multiplication of the two numbers, and add the result of the multiplication to a sum maintained in the multiply-accumulate (MAC) unit.

Each of the vector buffers 181 and 183 stores a list of numbers. A pair of numbers, each from one of the vector buffers 181 and 183, can be provided to each of the multiply-accumulate units 171 to 173 as input. The multiply-accumulate units 171 to 173 can receive multiple pairs of numbers from the vector buffers 181 and 183 in parallel and perform the multiply-accumulate (MAC) operations in parallel. The outputs from the multiply-accumulate units 171 to 173 are stored into the shift register 175; and an accumulator 177 computes the sum of the results in the shift register 175.

When the vector-vector unit 161 of FIG. 4 is implemented in a matrix-vector unit 141 of FIG. 3, the vector-vector unit 161 can use a maps bank (e.g., 151 or 153) as one vector buffer 181, and the kernel buffer 131 of the matrix-vector unit 141 as another vector buffer 183.

The vector buffers 181 and 183 can have a same length to store the same number/count of data elements. The length can be equal to, or the multiple of, the count of multiply-accumulate units 171 to 173 in the vector-vector unit 161. When the length of the vector buffers 181 and 183 is the multiple of the count of multiply-accumulate units 171 to 173, a number of pairs of inputs, equal to the count of the multiply-accumulate units 171 to 173, can be provided from the vector buffers 181 and 183 as inputs to the multiply-accumulate units 171 to 173 in each iteration; and the vector buffers 181 and 183 feed their elements into the multiply-accumulate units 171 to 173 through multiple iterations.

In one embodiment, the communication bandwidth of the connection 119 between the Deep Learning Accelerator 103 and the random access memory 105 is sufficient for the matrix-matrix unit 121 to use portions of the random access memory 105 as the maps banks 151 to 153 and the kernel buffers 131 to 133.

In another embodiment, the maps banks 151 to 153 and the kernel buffers 131 to 133 are implemented in a portion of the local memory 115 of the Deep Learning Accelerator 103. The communication bandwidth of the connection 119 between the Deep Learning Accelerator 103 and the random access memory 105 is sufficient to load, into another portion of the local memory 115, matrix operands of the next operation cycle of the matrix-matrix unit 121, while the matrix-matrix unit 121 is performing the computation in the current operation cycle using the maps banks 151 to 153 and the kernel buffers 131 to 133 implemented in a different portion of the local memory 115 of the Deep Learning Accelerator 103.

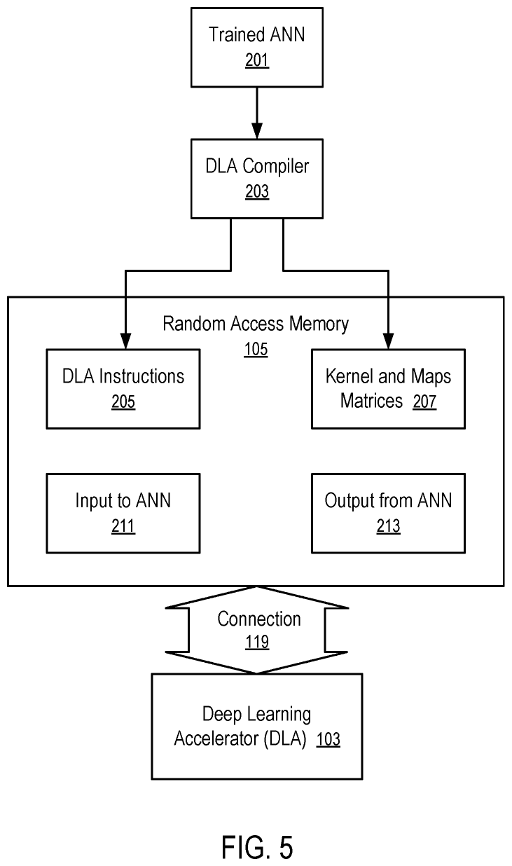

FIG. 5 shows a Deep Learning Accelerator and random access memory configured to autonomously apply inputs to a trained Artificial Neural Network according to one embodiment.

An Artificial Neural Network (ANN) 201 that has been trained through machine learning (e.g., deep learning) can be described in a standard format (e.g., Open Neural Network Exchange (ONNX)). The description of the trained Artificial Neural Network 201 in the standard format identifies the properties of the artificial neurons and their connectivity.

In FIG. 5, a Deep Learning Accelerator (DLA) compiler 203 converts trained Artificial Neural Network 201 by generating instructions 205 for a Deep Learning Accelerator 103 and matrices 207 corresponding to the properties of the artificial neurons and their connectivity. The instructions 205 and the matrices 207 generated by the DLA compiler 203 from the trained Artificial Neural Network 201 can be stored in random access memory 105 for the Deep Learning Accelerator 103.

For example, the random access memory 105 and the Deep Learning Accelerator 103 can be connected via a high bandwidth connection 119 in a way as in the integrated circuit device 101 of FIG. 1. The autonomous computation of FIG. 5 based on the instructions 205 and the matrices 207 can be implemented in the integrated circuit device 101 of FIG. 1. Alternatively, the random access memory 105 and the Deep Learning Accelerator 103 can be configured on a printed circuit board with multiple point to point serial buses running in parallel to implement the connection 119.

In FIG. 5, after the results of the DLA compiler 203 are stored in the random access memory 105, the application of the trained Artificial Neural Network 201 to process an input 211 to the trained Artificial Neural Network 201 to generate the corresponding output 213 of the trained Artificial Neural Network 201 can be triggered by the presence of the input 211 in the random access memory 105, or another indication provided in the random access memory 105.

In response, the Deep Learning Accelerator 103 executes the instructions 205 to combine the input 211 and the matrices 207. The execution of the instructions 205 can include the generation of maps matrices for the maps banks 151 to 153 of one or more matrix-matrix units (e.g., 121) of the Deep Learning Accelerator 103.

In some embodiments, the inputs 211 to the Artificial Neural Network 201 is in the form of an initial maps matrix. Portions of the initial maps matrix can be retrieved from the random access memory 105 as the matrix operand stored in the maps banks 151 to 153 of a matrix-matrix unit 121. Alternatively, the DLA instructions 205 also include instructions for the Deep Learning Accelerator 103 to generate the initial maps matrix from the input 211.

According to the DLA instructions 205, the Deep Learning Accelerator 103 loads matrix operands into the kernel buffers 131 to 133 and maps banks 151 to 153 of its matrix-matrix unit 121. The matrix-matrix unit 121 performs the matrix computation on the matrix operands. For example, the DLA instructions 205 break down matrix computations of the trained Artificial Neural Network 201 according to the computation granularity of the Deep Learning Accelerator 103 (e.g., the sizes/dimensions of matrices that loaded as matrix operands in the matrix-matrix unit 121) and applies the input feature maps to the kernel of a layer of artificial neurons to generate output as the input for the next layer of artificial neurons.

Upon completion of the computation of the trained Artificial Neural Network 201 performed according to the instructions 205, the Deep Learning Accelerator 103 stores the output 213 of the Artificial Neural Network 201 at a pre-defined location in the random access memory 105, or at a location specified in an indication provided in the random access memory 105 to trigger the computation.

When the technique of FIG. 5 is implemented in the integrated circuit device 101 of FIG. 1, an external device connected to the memory controller interface 107 can write the input 211 into the random access memory 105 and trigger the autonomous computation of applying the input 211 to the trained Artificial Neural Network 201 by the Deep Learning Accelerator 103. After a period of time, the output 213 is available in the random access memory 105; and the external device can read the output 213 via the memory controller interface 107 of the integrated circuit device 101.

For example, a predefined location in the random access memory 105 can be configured to store an indication to trigger the autonomous execution of the instructions 205 by the Deep Learning Accelerator 103. The indication can optionally include a location of the input 211 within the random access memory 105. Thus, during the autonomous execution of the instructions 205 to process the input 211, the external device can retrieve the output generated during a previous run of the instructions 205, and/or store another set of input for the next run of the instructions 205.

Optionally, a further predefined location in the random access memory 105 can be configured to store an indication of the progress status of the current run of the instructions 205. Further, the indication can include a prediction of the completion time of the current run of the instructions 205 (e.g., estimated based on a prior run of the instructions 205). Thus, the external device can check the completion status at a suitable time window to retrieve the output 213.

In some embodiments, the random access memory 105 is configured with sufficient capacity to store multiple sets of inputs (e.g., 211) and outputs (e.g., 213). Each set can be configured in a predetermined slot/area in the random access memory 105.

The Deep Learning Accelerator 103 can execute the instructions 205 autonomously to generate the output 213 from the input 211 according to matrices 207 stored in the random access memory 105 without helps from a processor or device that is located outside of the integrated circuit device 101.

Different types of memory cells can have different advantages in different memory usage patterns. The random access memory 105 can be configured using heterogeneous stacks of memory dies with burst buffers and/or inter-die copying functionality to maximize bandwidth and performance for the Deep Learning Accelerator 103.

For example, a memory device system tailored to the memory usage patterns of the Deep Learning Accelerator 103 can use 3D die stacking and 2.5D interposer-based interconnect of various memory types. The Deep Learning Accelerator 103 can be configured as a host of the memory device system. A memory controller in the memory interface 117 of the Deep Learning Accelerator 103 can be configured to fully schedule and orchestrate data movement in the memory device system for low complexity, power and jitter.

A small buffer and control logic can be implemented in a stack of a memory dies to execute commands configured to perform inter-die data copying operations in the stack. The inter-die copying operations within a stack can be used to account for differing memory technology geometries and speeds, while completing such operations with deterministic latency. Such an arrangement removes the need to handle non-deterministic commands using split-transaction bus interfaces and buffering.

Each layer of memory dies in a stack can be configured to optimize the holding of data of a predetermined type based on the types of data having different patterns of usage in the Deep Learning Accelerator 103. For example, during inference computing of an Artificial Neural Network 201, data representative of the kernels of the Artificial Neural Network 201 can reside in memory that is optimized for read operations; and data representative of maps/activations of the Artificial Neural Network 201 can reside in memory that is optimized for both read and write operations. During the training of the Artificial Neural Network 201, the data representative of the kernels of a portion of the Artificial Neural Network 201 can be moved to a memory that is optimized for write operations during updates of the Artificial Neural Network 201; and when the computation moves on to other operations (e.g., other neural network layers or kernel portions), the kernel data that have been updated can be shifted back to the memory that is optimized for read operations and that has high density to offer high storage capacity. A data mover can be configured in the stack of memory dies for optimized efficiency.

Preferably, a high bandwidth burst buffer is configured in a stack of memory dies to allow very rapid offload of data from the Deep Learning Accelerator 103 as a host. The Deep Learning Accelerator 103 can resume other operations while data in the burst buffer is more slowly migrated to a bulk memory die that has a higher storage capacity. Bulk memory dies can be heavily banked for improved bandwidth.

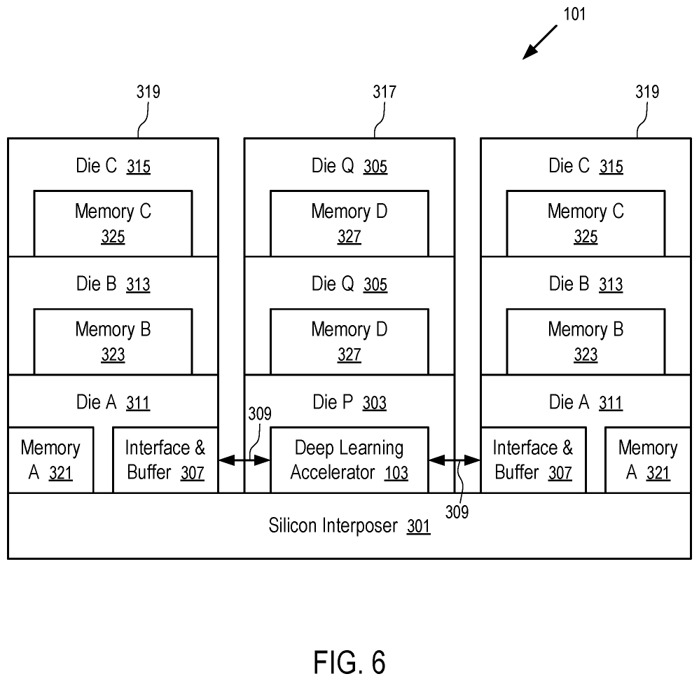

FIG. 6 illustrates a configuration of integrated circuit dies of memory and a Deep Learning Accelerator according to one embodiment.

For example, the configuration of FIG. 6 can be used to implement the integrated circuit device 101 of FIG. 1 and/or apply the computing illustrated in FIG. 5.

In FIG. 6, the integrated circuit device 101 as a plurality of stacks 317 and 319 of integrated circuit dies configured on a silicon interposer 301 (or another type of interposer, such as an organic interposer).

A deep learning accelerator 103 is configured in an integrated circuit die 303 in one of the plurality of stacks.

The stack 317 of integrated circuit dies 303 and 305 has the Deep Learning Accelerator 103 and can be referred to as a Deep Learning Accelerator stack 317. It has a plurality of memory dies 305 stacked on top of the die 303 of the deep learning accelerator 103. The memory interface 117 of the Deep Learning Accelerator 103 can have a memory controller that is connected to the memory dies 305 using Through-Silicon Vias (TSV) for high bandwidth access.

Preferably, the memory cells in the memory 327 of dies 305 are configured for low latency operations. For example, the type of the memory cells in the memory dies 305 can be selected such that the latency of accessing the memory cells in the memory dies 305 can be lower than accessing the memory cells in other stacks 319. FIG. 6 shows an example of stacking two memory dies 305 on the die 303 having the Deep Learning Accelerator 103. In general, more or less memory dies 305 can be used in the Deep Learning Accelerator stack 317.

A stack 319 of integrated circuit dies 311, 313 and 315 that does not have a Deep Learning Accelerator can be referred to a memory stack 319 for simplicity. Different types of memory cells can be used on different layers of the memory stacks 319.

For example, a base integrated circuit die 311 in a memory stack 319 can be connected to a memory controller of the deep learning accelerator 103 through a connection 309. High-performance signaling can be used for the connection 309 that connects an interface and buffer 307 of the memory die 311 and the memory controller of the Deep Learning Accelerator 103. For example, four-level pulse-amplitude modulation (PAM4) can support a high-speed connection (e.g., four-hundred gigabit) and thus provide a high communication bandwidth between the memory stack 319 and the Deep Learning Accelerator stack 317.

The interface and buffer 307 of the base die 311 includes a die crossing buffer that is used to buffer the data for transferring into or from memory dies 313 and 315 that are stacked on the base die 311 in the memory stack 319. The die crossing buffer allows the transfer of data in a burst mode between the memory stack 319 and the Deep Learning Accelerator stack 317 at a rate higher than the data transfer rate between the memory dies 313 and 315 in the memory stack 319 and the Deep Learning Accelerator stack 317. Memory 325 and memory 323 in the integrated circuit dies 313 and 315 stacked on the base die 311 can be connected using Through-Silicon Vias (TSVs) to the interface and buffer 307 in the base die 311 for access by the memory controller in the Deep Learning Accelerator stack 317 through the connection 309.

The interface and buffer 307 has logic circuit that can copy data in blocks between the die crossing buffer and the memory 323 and memory 325 in the memory dies 313 and 315. To minimize complexity and variability, the interface and buffer 307 can be configured to block copy data to or from the memory 323 and 325 within the memory stack 319 with a constant delay. The interface and buffer 307 of a memory stack uses a fixed number of clock cycles to copy a block of data between the die crossing buffer and another memory die (e.g., 313 or 315) in the same memory stack 319.

Preferably, memory cells in memory 321 of the base die 311 having the logic circuit of the interface and buffer 307 are selected to optimize read and write bandwidth. Memory cells in memory 323 of the die 313 are selected to optimize write operations with high memory cell density to offer high storage capacity. Memory cells in memory 325 of the die 315 are selected to optimize read operations with high memory cell density to offer high storage capacity. Optionally, one or more additional memory dies having memory similar to memory 325 and/or memory 323 can be used in the memory stack 319.

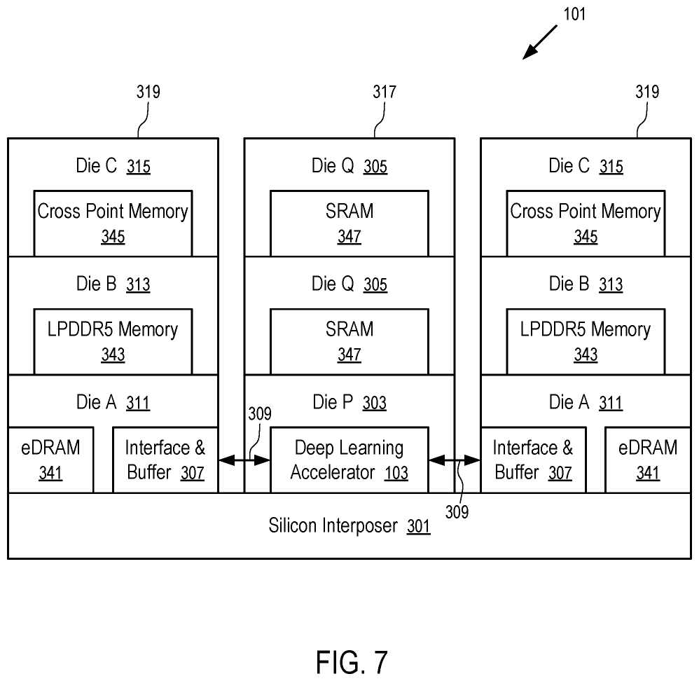

Examples of memory cells selected for the implementations of the memory 321, 323, 325 and 327 are discussed below in connection with FIG. 7.

FIG. 7 illustrates an example of memory configuration for a Deep Learning Accelerator according to one embodiment.

For example, the integrated circuit device 101 of FIG. 6 can be implemented using the example of FIG. 7.

In the example of FIG. 7, the memory 327 of FIG. 6 is implemented using Static Random-Access Memory (SRAM) 347; the memory 321 of FIG. 6 is implemented using Embedded Dynamic Random-Access Memory (eDRAM) 341; the memory 323 of FIG. 6 is implemented using Low-Power Double Data Rate 5 (LPDDR5) memory 343; and the memory 325 of FIG. 6 is implemented using cross point memory 345 (e.g., 3D XPoint). The Low-Power Double Data Rate 5 (LPDDR5) memory 343 can be implemented using Synchronous Dynamic Random-Access Memory (SDRAM). In other examples, alternative types of memories can be used. For example, instead of Low-Power Double Data Rate 5 (LPDDR5) memory 343, High Bandwidth Memory (HBM) in implemented using 3D-stacked SDRAM or DRAM can be used. In one example, the memory 327 of FIG. 6 is implemented using a memory that has the highest bandwidth and lowest latency in the memories 321 to 325; the memory 321 of FIG. 6 is implemented using a memory that is relatively dense, high-bandwidth, and low-latency among the memories 321 to 325; the memory 323 of FIG. 6 is implemented using a memory that is very dense, high bandwidth memory; and the memory 325 of FIG. 6 is implemented using a memory that is densest among the memories 321 to 325 and is read-optimized.

In FIG. 7, the memory die 315 has non-volatile memory cells of cross point memory 345. Data stored in the memory die 315 can be retained after the power to the integrated circuit device 101 is disrupted for an extended period of time. Thus, a copy of the DLA instructions 205 and the matrices 207 representative of the Artificial Neural Network 201 can be stored in the memory die 315 as a persistent portion of the Artificial Neural Network 201 configured in the integrated circuit device 101.

The integrated circuit in the base die 311 having the interface and buffer 307 can be manufactured using a process for forming logic circuits. Embedded Dynamic Random-Access Memory (eDRAM) 341 (or SRAM) can be formed in the base die 311 to provide the die crossing buffer.

Preferably, the memory system provided in the integrated circuit device 101 is configured such that the memory controller in the memory interface 117 of the Deep Learning Accelerator 103 can access any of the memory dies 305, 311, 313, and 315 in any of the stacks 317 and 319, when the corresponding bank of memory in the die is not currently being used by a corresponding interface and buffer 307.

To read a block of data from a memory stack 319, the memory controller of the Deep Learning Accelerator 103 can issue a read command to directly address a memory block in the memory stack 319. The memory block may be in any of the memory dies 311, 313 and 315 in the memory stack 319. The memory controller reads the block of data from the memory stack 319 into the Static Random-Access Memory (SRAM) 347 in the Deep Learning Accelerator stack 317.

Alternatively, to minimize the time used in reading the block of data from the memory stack 319, the memory controller of the Deep Learning Accelerator 103 can issue a command to the interface and buffer 307 to prefetch the block of data from a memory die (e.g., 313 or 315) into the die crossing buffer in the base die 311. Based on the constant latency of the operation of the interface and buffer 307, the DLA compiler 203 can determine and track where data currently is and where the data will be consumed. After the data is in the Embedded Dynamic Random-Access Memory (eDRAM) 341 in the base die 311, the memory controller of the Deep Learning Accelerator 103 can issue a command to read the data from the Embedded Dynamic Random-Access Memory (eDRAM) 341 into the Static Random-Access Memory (SRAM) 347 of the Deep Learning Accelerator stack 317, which is faster than reading the data from memory dies 313 and 315 into the Deep Learning Accelerator stack 317.

To write a block of data to a memory stack 319, the memory controller of the Deep Learning Accelerator 103 writes data to the Embedded Dynamic Random-Access Memory (eDRAM) 341 to complete the operation as quickly as possible. The memory controller of the Deep Learning Accelerator 103 can then issue a block copy command for the interface and buffer 307 to copy the block of data to a bulk memory die (e.g., 313 or 315) that is stacked on the base die 311.

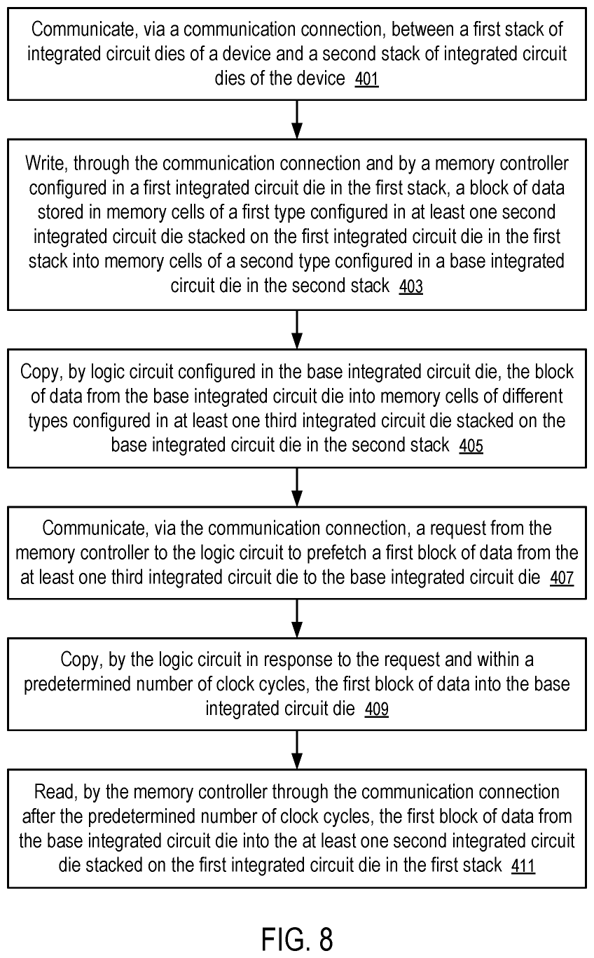

FIG. 8 shows a method implemented in an integrated circuit device according to one embodiment. For example, the method of FIG. 8 can be implemented in the integrated circuit device 101 of FIG. 1, FIG. 6 and/or FIG. 7, or another device similar to that illustrated in FIG. 5.

At block 401, a first stack 317 of integrated circuit dies 303 and 305 of a device 101 communicates, via a communication connection 309, with a second stack 319 of integrated circuit dies 311, 313 and 315 of the device 101.

For example, the communication connection 309 can be configured to transmit signaling modulated or encoded according to various schemes, including non-return to zero (NRZ), pulse-amplitude modulation (PAM), or the like. Communication connection 309 may include one or more designated data channels or buses and one or more command/address (or C/A) channels or buses. In some examples, the data channels, which may be referred to as DQs, may be bidirectional, allowing signaling or bit streams representative of data to be transferred between (e.g., read from or written to) devices coupled to communication connection 309. Command/addresses buses within communication connection 309 may be unidirectional or bidirectional.

For example, the device 101 can have a silicon interposer 301 on which the stacks 317 and 319 are mounted.

For example, the communication connection 309 can be provided via the silicon interposer 301.

For example, an integrated circuit package can be configured to enclose the device 101.

For example, memory 327 of the integrated circuit dies 303 and 305 in the first stack 317 can be connected to a memory controller in the first stack 317 using Through-Silicon Vias (TSVs); memory 323 of integrated circuit die 313 and memory 325 of integrated circuit die 315 in the second stack 319 can be connected to the logic circuit of an interface and buffer 307 in the second stack 317 using Through-Silicon Vias (TSVs). The memory controller in the first stack 317 and the interface and buffer 307 in the second stack 317 can communicate with each other using the communication connection 309.

At block 403, through the communication connection 309, a memory controller of a memory interface 117 configured in a first integrated circuit die 303 in the first stack 317 copies a block of data, stored in memory cells of a first type configured in at least one second integrated circuit die 305 stacked on the first integrated circuit die 303 in the first stack 317, into memory cells of a second type configured in a base integrated circuit die 311 in the second stack 319.

At block 405, logic circuit of an interface and buffer 307 configured in the base integrated circuit die 311 copies the block of data, from the base integrated circuit die 311, into memory cells configured in at least one third integrated circuit die (e.g., 313, 315) stacked on the base integrated circuit die 311 in the second stack 319. Memory cells in the at least one third integrated circuit die (e.g., 313, 315) can have different types and can be different from the first type of memory 327 in the at least one second integrated circuit die 305 and different from the second type of memory 321 in the base integrated circuit die 311.

At block 407, the memory controller of the memory interface 117 communicates, via the communication connection 309, a request to the logic circuit of the interface and buffer 307 to prefetch a first block of data from the at least one third integrated circuit die (e.g., 313, 315) to the base integrated circuit die 311.

At block 409, in response to the request and within a predetermined number of clock cycles, the logic circuit of the interface and buffer 307 copies the first block of data into the base integrated circuit die 311.

At block 411, after the predetermined number of clock cycles, the memory controller of the memory interface 117 copies through the communication connection 309 the first block of data from the base integrated circuit die 311 into the at least one second integrated circuit die 305 stacked on the first integrated circuit die 303 in the first stack 317.

For example, the memory cells of the different types configured in the at least one third integrated circuit die (e.g., 313 and 315) can have different speeds in memory access. To reduce complexity, the predetermined number of clock cycles can be independent of a type of memory cells in which the first block of data is stored in the at least one third integrated circuit die (e.g., 313 and 315). For example, the logic circuit of the interface and buffer 307 can copy a block of data from volatile memory 323 (e.g., SDRAM) to the base integrated circuit die 311 using the same predetermined number of clock cycles for copying the data from non-volatile memory 325 (e.g., cross point memory).

Optionally, the memory controller of the memory interface 117 can read a second block of data from the at least one third integrated circuit die (e.g., 313, 315) into the at least one second integrated circuit die 305 without requesting the logic circuit of the interface and buffer 307 to prefetch the second block of data into the base integrated circuit die 311. Without the prefetching request, the connection 309 will be occupied for the reading of the second block of data for a longer period of time than the sum of the time used to request prefetching to the base integrated circuit die 311 and the time used to copy from the base integrated circuit die 311. When prefetching is used, some of the resources used for the reading of the second block data can be freed for other operations during the time period between the request for prefetching and the copying/reading of the prefetched data from the base integrated circuit die 311 into the first stack 317.

Preferably, the memory cells in the memory dies (e.g., 305, 313, 315) are organized in many banks that can be used separately. Thus, when a bank of memory cells in a memory die (e.g., 313 or 315) are being used by the interface and buffer 307, another bank of memory cells that are in the same memory die (e.g., 313 or 315) but not currently being used by the interface and buffer 307 can be addressed concurrently by the memory controller in the memory interface 117 of the Deep Learning Accelerator 103.

For example, the first type of memory 327 configured in memory dies 305 stacked on the first integrated circuit die 303 can be Static Random-Access Memory (SRAM); the second type of memory 321 configured in the base integrated circuit die 311 can be Embedded Dynamic Random-Access Memory (eDRAM). The at least one third integrated circuit die can include a die 313 of memory 323 that is Synchronous Dynamic Random-Access Memory (SDRAM) and another die 315 of memory 325 that is cross point memory.

For example, the non-volatile memory 325 can be used to store data representative of an Artificial Neural Network (ANN). The data can be read into the volatile memory 327 having low latency stacked on top of the first integrated circuit die 303 to perform matrix computations of the Artificial Neural Network (ANN) using processing units 111 in the first integrated circuit die 303.

For example, the first integrated circuit die 303 can include a Field-Programmable Gate Array (FPGA) or Application Specific Integrated circuit (ASIC) implementing a Deep Learning Accelerator 103. The Deep Learning Accelerator 103 can include a memory controller in its memory interface 117, a control unit 113, and at least one processing unit 111 configured to operate on two matrix operands of an instruction executed in the FPGA or ASIC.

The present disclosure includes methods and apparatuses which perform the methods described above, including data processing systems which perform these methods, and computer readable media containing instructions which when executed on data processing systems cause the systems to perform these methods.

A typical data processing system can include an inter-connect (e.g., bus and system core logic), which interconnects a microprocessor(s) and memory. The microprocessor is typically coupled to cache memory.

The inter-connect interconnects the microprocessor(s) and the memory together and also interconnects them to input/output (I/O) device(s) via I/O controller(s). I/O devices can include a display device and/or peripheral devices, such as mice, keyboards, modems, network interfaces, printers, scanners, video cameras and other devices known in the art. In one embodiment, when the data processing system is a server system, some of the I/O devices, such as printers, scanners, mice, and/or keyboards, are optional.

The inter-connect can include one or more buses connected to one another through various bridges, controllers and/or adapters. In one embodiment the I/O controllers include a USB (Universal Serial Bus) adapter for controlling USB peripherals, and/or an IEEE-1394 bus adapter for controlling IEEE-1394 peripherals.

The memory can include one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory can also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In the present disclosure, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques can be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments can be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data can be stored in various places including for example ROM, volatile RAM, non-volatile memory and/or cache. Portions of this software and/or data can be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to non-transitory, recordable and non-recordable type media such as volatile and non-volatile memory devices, Read Only Memory (ROM), Random Access Memory (RAM), flash memory devices, floppy and other removable disks, magnetic disk storage media, optical storage media (e.g., Compact Disk Read-Only Memory (CD ROM), Digital Versatile Disks (DVDs), etc.), among others. The computer-readable media can store the instructions.

The instructions can also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry can be used in combination with software instructions to implement the techniques. Thus, the techniques are neither limited to any specific combination of hardware circuitry and software nor to any particular source for the instructions executed by the data processing system.

The above description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

In the foregoing specification, the disclosure has been described with reference to specific exemplary embodiments thereof. It will be evident that various modifications can be made thereto without departing from the broader spirit and scope as set forth in the following claims. The specification and drawings are, accordingly, to be regarded in an illustrative sense rather than a restrictive sense.

What is claimed is:

1. A device, comprising:
a first stack of integrated circuit dies, including:
a first integrated circuit die containing a memory controller and processing units configured to perform at least computations on matrix operands; and
at least one second integrated circuit die stacked on the first integrated circuit die and containing memory cells of a first type;
a plurality of second stacks of integrated circuit dies, each respective stack in the plurality of second stacks including:
a base integrated circuit die containing logic circuit and memory cells of a second type; and
at least one third integrated circuit die stacked on the base integrated circuit die and containing memory cells that are different from the first type and different from the second type; and
a plurality of communication connections, each of the communication connections configured between the memory controller in the first stack and the logic circuit of the respective stack.

2. The device of claim 1, further comprising:
an interposer, wherein the first stack and the plurality of second stacks are configured on the interposer.

3. The device of claim 2, further comprising:
an integrated circuit package configured to enclose the device.

4. The device of claim 3, wherein the at least one second integrated circuit die includes at least two integrated circuit dies connected to the memory controller using Through-Silicon Vias (TSVs) and having the memory cells of the first type.

5. The device of claim 4, wherein the at least one third integrated circuit die includes at least two integrated circuit dies connected to the memory controller through Through-Silicon Vias (TSVs) and having memory cells of a third type and memory cells of a fourth type; and wherein the memory cells of the third type are volatile and the memory cells of the fourth type are non-volatile.

6. The device of claim 5, wherein the first type has bandwidth and latency performance better than the second type, the third type and the fourth type; the second type has latency performance better than the third type and the fourth type and has memory cell density higher than the first type; the third type has memory cell density higher than the second type and has bandwidth performance better than the fourth type; and the fourth type has memory cell density and storage capacity higher than the third type.

7. The device of claim 5, wherein the logic circuit in the base integrated circuit die is configured to receive a command from the memory controller in the first integrated circuit die and execute the command to copy data between the base integrated circuit die and the at least one third integrated circuit die stacked on the base integrated circuit die.

8. The device of claim 7, wherein when the memory cells are not used the logic circuit, the memory cells in the at least one third integrated circuit die are addressable by the memory controller directly for read or write.

9. The device of claim 8, wherein memory cells in the plurality of second stacks are accessible in parallel to the memory controller via the plurality of communication connections.

10. The device of claim 9, wherein during execution of a write command,
the memory controller is configured to write a block of data into the memory cells of the second type in the base integrated circuit die, and
the logic circuit is configured to copy the block of data from the base integrated circuit die into the at least one third integrated circuit die stacked on the base integrated circuit die.

11. The device of claim 9, wherein in a first mode of reading data from the at least one third integrated circuit die stacked on the base integrated circuit die, the memory controller is configured to copy a block of data from the at least one third integrated circuit die stacked on the base integrated circuit die into the at least one second integrated circuit die stacked on the first integrated circuit die.

12. The device of claim 11, wherein in a second mode of reading data from the at least one third integrated circuit die stacked on the base integrated circuit die, the memory controller is configured to:
instruct the logic circuit in the base integrated circuit die to copy the block of data from the at least one third integrated circuit die into the base integrated circuit die; and
after expiration of a predetermined number of clock cycles, copy the block of data from the base integrated circuit die into the at least one second integrated circuit die stacked on the first integrated circuit die.

13. A method, comprising:
communicating, via a communication connection, between a first stack of integrated circuit dies of a device and a second stack of integrated circuit dies of the device;
writing, through the communication connection and by a memory controller configured in a first integrated circuit die in the first stack, a block of data stored in memory cells of a first type configured in at least one second integrated circuit die stacked on the first integrated circuit die in the first stack into memory cells of a second type configured in a base integrated circuit die in the second stack; and
copying, by logic circuit configured in the base integrated circuit die, the block of data from the base integrated circuit die into memory cells of different types configured in at least one third integrated circuit die stacked on the base integrated circuit die in the second stack.

14. The method of claim 13, further comprising:
communicating, via the communication connection, a request from the memory controller to the logic circuit to prefetch a first block of data from the at least one third integrated circuit die to the base integrated circuit die;
copying, by the logic circuit in response to the request and within a predetermined number of clock cycles, the first block of data into the base integrated circuit die; and
reading, by the memory controller through the communication connection after the predetermined number of clock cycles, the first block of data from the base integrated circuit die into the at least one second integrated circuit die stacked on the first integrated circuit die in the first stack.

15. The method of claim 14, further comprising:
reading, by the memory controller through the communication connection after the predetermined number of clock cycles, a second block of data from the at least one third integrated circuit die into the at least one second integrated circuit die stacked on the first integrated circuit die in the first stack without requesting the logic circuit to prefetch the second block of data into the base integrated circuit die.

16. The method of claim 15, wherein the memory cells of the different types configured in the at least one third integrated circuit die have different speeds in memory access; and the predetermined number of clock cycles is independent of a type of memory cells in which the first block of data is stored in the at least one third integrated circuit die.

17. The method of claim 16, further comprising:
storing, in the at least one third integrated circuit die, data representative of an Artificial Neural Network (ANN); and
performing, by processing units configured in the first integrated circuit die in the first stack, matrix computations of the Artificial Neural Network (ANN) using the data representative of an Artificial Neural Network (ANN).

18. An apparatus, comprising:
a silicon interposer;
a first stack of integrated circuit dies configured on the silicon interposer, the first stack including:
a first integrated circuit die containing a Field-Programmable Gate Array (FPGA) or Application Specific Integrated circuit (ASIC), including:
a memory controller;
a control unit; and
at least one processing unit configured to operate on two matrix operands of an instruction executed in the FPGA or ASIC; and
at least two second integrated circuit die stacked on the first integrated circuit die and containing memory cells of a first type;
a plurality of second stacks of integrated circuit dies configured on the silicon interposer, each respective stack in the plurality of second stacks including:
a base integrated circuit die containing logic circuit and memory cells of a second type;
a third integrated circuit die stacked on the base integrated circuit die and containing memory cells of a third type; and
a fourth integrated circuit die stacked on the third integrated circuit die and containing memory cells of a fourth type; and
a plurality of communication connections configured on the silicon interposer, each respective connection in the plurality of the communication connections configured to connect the memory controller in the first stack and the logic circuit of the respective stack.

19. The apparatus of claim 18, wherein the logic circuit is configured to copy a data block within the respective stack in response to a command from the memory controller over the respective communication connection with a predetermined latency.

20. The apparatus of claim 19, wherein the first type has bandwidth and latency performance better than the second type; the second type has latency performance better than the third type and has memory cell density higher than the first type; the third type has memory cell density higher than the second type and has bandwidth performance better than the fourth type; and the fourth type has memory cell density higher than the third type.
